(19) United States
(12) Patent Application Publication
(10) Pub. No.: US 2025/0216580 A1
(43) Pub. Date: Jul. 3, 2025

(54) METHOD AND SYSTEM FOR EXPLOITING A SUBTERRANEAN RESERVOIR

(71) Applicant: Abu Dhabi National Oil Company, Abu Dhabi (AE)

(72) Inventors: Travis St. George RAMSAY, Abu Dhabi (AE); Rahul Mark FONSECA, Abu Dhabi (AE)

(73) Assignee: Abu Dhabi National Oil Company, Abu Dhabi (AE)

(21) Appl. No.: 18/849,170

(22) PCT Filed: May 2, 2022
(86) PCT No.: PCT/IB2022/054028

§ 371 Date: Sep. 20, 2024

(51) Int. Cl. G01V 20/00

(52) U.S. Cl. CPC G01V 20/00; G01V 2210/6169; G01V 2210/667

(57) ABSTRACT

The present invention relates to a method for simulating at least one characteristic of a hydrocarbon subterranean reservoir for exploiting said reservoir, wherein the reservoir is characterized by at least a first, a second, and a third property, wherein the first, the second, and the third properties are different from one another and linked to each other according to a relationship.

### TECHNICAL FIELD

The present invention relates to a method for simulating at least one characteristic of a hydrocarbon subterranean reservoir for exploiting the reservoir. The invention further relates to a system for simulating at least one characteristic of a hydrocarbon subterranean reservoir for exploiting the reservoir.

### TECHNICAL BACKGROUND

Hydrocarbons are naturally present in geological formations beneath the earth's surface, i.e. hydrocarbon subterranean reservoirs, and represent primary energy resources. Those hydrocarbons can be further processed into suitable energy forms to address the energy demand of the earth's population.

Hydrocarbon subterranean reservoirs are typically rocks characterized or described by several characteristics or properties. Among these are seismic, well log, and petrophysical properties, which vary in space, for instance along different spatial locations of a reservoir, and scale, for instance between a coarse scale and a fine scale, and which can be highly dependent upon other reservoir properties. For instance, the pressure in the reservoir may depend upon the temperature of the reservoir. Further examples of properties of a reservoir include the porosity of the reservoir (such as non-solid material spaces) occurring within the geologic medium, the permeability of the reservoir (such as fluid flow capability) and the hydrocarbon saturation of the reservoir (such as volumes of hydrocarbons relative to other fluids). The values of these and other properties typically have to meet certain criteria in order to exploit the reservoir for instance by means of well logs. In particular, knowledge of the values of the properties facilitates decision making for instance for improved well placements and well operation and thus provides for cost-effective and economic advantages. Therefore, it is of utmost importance to be aware of and to know a value or values of these properties. Knowledge of a value or values of these properties for future time instants, e.g. knowledge of their development over time, bears the potential to further improve decision making.

To determine a values or values of properties, well log or sonic log measurements can be performed, which are, however, expensive, limited due to testing procedures or operational time constraints and/or subject to inaccuracies inherently linked to the measurements. Consequently, the measurement data needs to be corrected while processing the data, which is an exhaustive task. Oftentimes, time and/or cost limitations are a dominant factor to dispense with acquiring, correcting and/or processing values of properties. Moreover, the interpretation of values of properties that are representative of more complex subsurface reservoirs poses difficulties and may not be determined. Further, not all properties can be captured by way of measurements and their values cannot be measured for future time instants. For instance, dry rock properties are typically measured in core samples or are dependent on a reference description. The optimal description would be sourced from direct testing which is often omitted due to cost.

It is known to perform reservoir simulation to predict the properties of a reservoir. In particular, reservoir simulation is a branch of fluid mechanics and addresses the numerical simulation of multiphase flow through heterogeneous porous media in the form of subterranean hydrocarbons (e.g. oil or gas) reservoirs. The production of oil and gas by drilling one or more wells into these reservoirs is typically accompanied by a co-production of water that is always naturally present in any hydrocarbon reservoir. In order to increase the oil production and to ensure sufficient reservoir pressure, it is often necessary to also drill one or more injection wells. Thus, gas, water, or chemicals, such as polymers can be injected into the reservoir to increase the water viscosity. The flow through one or more injection and one or more production wells is controlled by specifying flow rates, pressures, and valve settings in the wells, which may vary over time. Against this background, an optimal operation of the wells of the reservoir is dependent upon a multitude of properties, which further are dependent upon time and space, such as different spatial locations of a reservoir.

However, there still remains a vast number of properties whose value or values cannot be determined at all or cannot be determined with a sufficient accuracy or in a fast and cost-efficient way. This therefore poses a problem which can be referred to as a small data challenge, i.e. some data is known, wherein some data is not known in a multi-disciplinary system. In other words, small data challenge can be described as where there exists an overabundance of some data or data types compared to other data or data types which are absent or limited. This demands for data augmentation methods to facilitate determination of such missing data.

Thus, a demand exists to provide a method for determining a value or values of a property or properties of a hydrocarbon subterranean reservoir in a cost-effective and fast way.

Efforts have been made in US 2021/0149070 A1, which relates to a subsurface reservoir modeling method for applying elastic property constraints to model a distribution of pseudo-components. The proposed method is limited to metaheuristic optimization processes, in particular it is restricted to variable neighbor particle swarm optimization (VNPSO) with exterior penalty function (EPF). Furthermore, it comprises a nested optimization approach and is thus limited to specific workflows. Moreover, the VNPSO+EPF approach to data augmentation is time and computationally intensive.

Further attempts have been made to provide for respective data augmentation methods for exploitation of reservoirs using numerical models. Reference is exemplarily made to the contribution of Travis Ramsay and Halliburton, “Small Data Driven Metaheuristic Petro-Elastic Model Development Using Seismic Inversion”, SPE-195491-MS presented at the EAGE Conference and Exhibition held in London, UK, (2019), and the contribution of Brandon Thibodeaux et al., “Closed-Loop Integrated Time-Lapse Seismic Feasibility in Amberjack Field-Deepwater Offshore Gulf of Mexico”, SPE-196670-MS presented at the Reservoir Characterisation and Simulation Conference and Exhibition held in Abu Dhabi, UAE, (2019). The techniques of both of these contributions have limitations and deficiencies similar to US 2021/0149070 A1.

Against this background, an object of the present invention is to improve the deficiencies of the prior art. It is particularly an object to provide an improved method to augment unknown data in a field, characterized by small data challenge. It is an object to provide a method for improving and facilitating the simulation of characteristics of a hydrocarbon subterranean reservoir for exploiting the reservoir. It is generally an object to improve the exploitation of subsurface reservoirs.

These and other objects, which become apparent from the following description, are solved by the method according to claim 1, the system according to claim 15 and the computer program according to claim 16.

### SUMMARY OF THE INVENTION

An aspect of the invention relates to a method for simulating at least one characteristic of a hydrocarbon subterranean reservoir for exploiting said reservoir. The method may be applied for determining and predicting characteristics of a reservoir to facilitate for instance an optimal production or exploitation of the reservoir. In one example, production rates may beneficially be adjusted according to the simulated characteristics, which improves exploitation in an economic manner. Further, the method may aid in determining characteristics that cannot be otherwise measured with high accuracy in a cost-efficient manner. Thus, eventually exploitation of the reservoir is enhanced.

A characteristic or characteristics of a hydrocarbon subterranean reservoir may be understood as comprising any parameters that are associated with the reservoir and that may be employed to describe and/or to exploit the reservoir. In one example, this may include a reservoir pressure, a wellbore damage or barriers and permeability changes. A characteristic or characteristics of a reservoir may also describe a behavior or condition of a reservoir.

The reservoir is characterized by at least a first, a second, and a third property, wherein the first, the second, and the third properties are different from one another and linked to each other according to a relationship. The reservoir may be characterized by several properties. Exemplarily, the reservoir may be characterized by static and/or dynamic reservoir properties such as petro-physical, rock-physic and/or geo-mechanical properties. Further examples are the primary-wave velocity (Vp) and the secondary-wave velocity (Vs). Moreover, a relationship between at least a first, second and third property is provided. This relationship may be a physical relationship, i.e. the properties may be related to each other according to one or more physical laws which may be expressed by way of a mathematical formula. The relationship can also be established by way of one or more empirical laws, wherein a behavior of the first, second and third properties has been previously observed in order to determine a relationship between them. As an example, it may be known that the primary-wave velocity (Vp) is sensitive to the fluid properties in rock pores. This dependency of these two properties may be described empirically. Similarly, it may be known that the secondary-wave velocity (Vs) is insensitive to fluid properties. Further, it may be possible to use the ratio Vp/Vs for classifying lithologies of the reservoir to establish a relationship. The relationship may also be provided by way of a combination of one or more physical laws and one or more empirical laws. One property of the reservoir may be defined or described by other properties of the reservoir, wherein this definition or description may be provided by the relationship.

The method comprises the step of determining a value of the first property of the reservoir, comprising the steps of: providing a predetermined value of the second property of the reservoir; providing an input value of the third property of the reservoir; providing a first uncertainty distribution of the first property of the reservoir; and performing an optimization operation using at least partially the first uncertainty distribution, the predetermined value of the second property, the relationship between the properties, and the input value of the third property in determining the value of the first property. A property of the reservoir, such as the pressure, may have a value. A property may be dependent upon time and space, and may vary along a spatial location of the reservoir. Thus, a property may also have two or more, or multiple values, such as any tensor (an algebraic object that describes a multilinear conditions between sets of algebraic objects related to a vector space), i.e. permeability, or connected porosity. The uncertainty distribution may also be considered as comprising a range of values, e.g. a range of plausible values.

The value of the first property, which may initially be unknown, is determined.

A predetermined value of the second property is provided. The predetermined value of the second property may have been previously derived using suitable measurement techniques or based on one or more previous applications of the method according to an embodiment of the present invention or estimated based on, e.g. engineering expertise.

Further, an input value of the third property is provided. For example, the input value of the third property may have been previously derived using suitable measurement techniques or based on one or more previous applications of the method according to an embodiment of the present invention or estimated based on, e.g. engineering expertise or based on a random guess derived on a distribution or plausible numerical range of values.

A first uncertainty distribution of the first property is provided. Preferably this distribution has a lower end and an upper end of values based on applicable values of the first property, i.e. values which may be considered physically applicable. However, also different lower end and upper end values of the distribution may be applied, for instance based on engineering expertise. Thus, the first uncertainty distribution of the first property of the reservoir may be based at least in part on a predetermined range of values associated with the first property. This may be advantageous when it is desired to restrict the value or values of the first property to be determined to physically applicable values. Furthermore, suitable shapes of the uncertainty distribution, i.e. shapes of respective functions describing the uncertainty distribution when graphically represented or shapes of the uncertainty distribution when graphically represented, may comprise a uniform, normal or Gaussian, u-shaped, triangle-shaped, quadratic, log-normal, negatively skewed, or positively skewed uncertainty distribution. It may also be possible to use combinations of such distributions. In particular, the shape of the uncertainty distribution may be designed for the first property. Providing such a first uncertainty distribution beneficially facilitates the consideration of any variances that typically prevail in properties such as the first property. For instance, properties may be subject to structural variances or uncertainties, such as variances or uncertainties of a gross rock volume as the first property or variances or uncertainties of pore pressures as the first property. The variances or uncertainties may also be classified according to uncertainty maps, which may be obtained from wavelength and/or amplitude maps associated with properties of the reservoir. This is advantageous, since providing variations in a property to be determined may lead to an improved determination of a value of this property. This improved determination may facilitate to derive conclusions for an improved exploitation of a reservoir. Typically, variations or changes in the underlying properties of a reservoir always pertain at least to some degree. For instance, the first property may be the permeability of the reservoir, wherein the respective value may be estimated to be in the range between a lower end x1 and an upper end x2. The distribution may range between x1 and x2. Further, the distribution can be described by a normal or Gaussian shape, such that values close to but greater than the lower end x1 and values close to but smaller than the upper end x2 are less likely to occur than values of a mean value of x1 and x2. The distribution can also be described by a uniform shape, such that each value occurs with the same likelihood. For example, the uncertainty distribution may also be considered as a range of values or a range of plausible values. Preferably, the distribution has a shape that is not uniform. A not uniform shape of the distribution may be understood such that values of the distribution in the range of x1 and x2 occur with a different likelihood and/or that at least one value has a different likelihood of occurrence than one or more of the other values.

The determination of the value of the first property further comprises performing an optimization operation using at least partially the first uncertainty distribution, the predetermined value of the second property, the relationship between the properties, and the input value of the third property in determining the value of the first property. An optimization operation may be understood as a selection of a best or optimal element/elements or best or optimal value/values according to one or more criteria from some available elements or values. The criteria may be based on one or more properties or values associated with optimization operation. For example, an optimization operation may comprise maximizing or minimizing an objective function, wherein the objection function can comprise one or more criteria.

The optimization operation may comprise minimizing a difference between the input value of the third property and a calculated value, wherein the calculated value may be determined using the relationship between the properties, the first uncertainty distribution and the predetermined value of the second property. Thereby, the value of the first property can be determined in a fast and cost-effective way to a high degree of accuracy. Consideration of the uncertainty distribution even further improves the accuracy and reliability of the determination of the value of the first property.

In a further step, the method comprises applying the determined value of the first property in simulating the at least one characteristic of the hydrocarbon subterranean reservoir for exploiting said reservoir. Thus, the value of the first property determined previously by performing the optimization operation is now applied in the context of simulating the at least one characteristic of the reservoir. In other words, the value determined accurately by considering the first uncertainty distribution now allows for an improved exploitation of the reservoir.

It may be possible to apply the method of the invention to simulate the behavior of the reservoir over a potentially long period of time with high accuracy and to thereby improve exploitation of the reservoir. An improved exploitation may exemplarily entail that well logs are placed based at least partially on the simulated characteristic/characteristics of the reservoir. Another example is that parameters associated to placed well logs are adjusted in order to increase the production of the reservoir. Further, the method improves existing integrated workflows, such as geo-mechanical modeling, virtual wireline logging, geo-steering, 4D seismic-driven history matching and other workflows. In particular, the method provides for considering a statistical evaluation of determined data, such as the first property, and thereby improves exploitation of the reservoir.

The method's application may expand to other technical fields and across disciplines comprising data and or properties of multiple dimensions that are characterized by limited or missing data. In one example, the method may be a computer implemented method. The entire method may be computer implemented or only some of the method steps.

In the above, one or more of the first, second and or third property may be of a N-dimensional structure, wherein N is a number greater than 0, 1, 2, or greater or equal to 3. Further, one or more of the first, second and or third property may also each be dependent upon space and time and/or comprise a multitude of sub-properties.

In a preferred embodiment, performing the optimization operation comprises calculating sampling values of the first property based at least partially on the first uncertainty distribution of the first property; calculating output values of the third property based at least partially on the relationship between the properties and the calculated sampling values of the first property; selecting a value of the calculated output values of the third property closest to the input value of the third property; and determining the respective value of the first property from the calculated sampling values of the first property corresponding to the selected value of the calculated output values of the third property closest to the input value of the third property. The method comprises calculating sampling values of the first property, which is the property of the reservoir that is not known and needs to be determined. This calculation is performed using at least partially the first uncertainty distribution of the first property. For instance, the sampling values are calculated based on their probability of occurrence according to the first uncertainty distribution. Variances or varying values that are typically inherent to such a property can advantageously be considered with the uncertainty distribution. The output values of the third property are calculated based on the relationship between the properties, e.g. the first, second and third properties. In this calculation step, the sampling values are used as values for the first property. Furthermore, the provided predetermined value of the second property of the reservoir is used in the relationship between the properties to calculate the output values. The properties may have a multitude of dimensions, e.g. with respect to space or with respect to spatial axes of the reservoir and with respect to time and therefore may provide for a relationship, which may not be solved for an unknown value in a straightforward way.

In one example, an unknown value of a property, such as the first property, linked by a relationship to another property or properties, such as the second and the third property, may be calculated by way of an explicit calculation scheme. In another example, this may not be the case such that the unknown value may not explicitly be calculated by way a simple reformulation of the relationship. Preferably all sampling values of the first property are used as values for the first property in the relationship between the first, second and third properties to calculate the output values of the third property. Then, one value of the calculated output values of the third property is selected, which is preferably the closest value to the input value of the third property. In this regard, the closest value may be that value being closest to the input value of the third property, based on an absolute difference between the input value and the output value of the third property. Furthermore, in case of multi-dimensional properties, selecting a value of the calculated output value may be performed using an L1-Norm, i.e. by forming the sum of the absolute differences between the calculated output value in each dimension and the input value in each dimension. In another example, selecting a value of the calculated output value may be performed using an L2-Norm, i.e. by forming the sum of the square of the differences between the calculated output value in each dimension and the input value in each dimension. Further, the method comprises determining the respective value of the first property from the calculated sampling values, that corresponds to the selected value of the calculated output values of the third property. This means that a value of the first property is determined, which, when this value of the first property is used in the relationship between the properties, yields to the calculated selected value of the calculated output values of the third property. The method can aid in determining the value of the first property in a cost-effective and statistically robust manner by considering underlying variances in the values of the first property.

Preferably, the values of one or more of the first property, second property, third property have a first data type, and the values of one or more other of the first property, second property, third property have a second data type different from the first data type. A data type of a value may be understood as a way to describe how a value can be represented, used and/or processed. For instance, an integer may be a data type that represents numbers, e.g. without floating point. As a further example, real values can be represented by floating points. Other examples of data types comprise characters, strings or Booleans. The data type of for instance a value or values of the first property may be different than the data type of a value or values of the second property. Thus, the method can cope with different data types. Values of reservoir properties typically have different data types and reflecting these may improve the accuracy of the determination of missing values of properties. This may be enabled by Integer programming which may be understood as a technique, wherein values of properties may be restricted to be integers. Thus, the exploitation of the reservoir can be improved.

Further preferred, the first data type is an integer-value data type, and the first data type is conserved during the step of performing the optimization operation. Further preferred, the first data type is conserved during any or all steps of the method. One or more properties may be of an integer-value data type which may be conserved or maintained during performing the optimization operation. Thus, the data type is not being altered. For instance, an integer remains an integer, preferably throughout the method. Thus, the method may beneficially not require pre-and/or post-processing to alter a data type before and/or after the optimization operation or during any other step of the method. This pre-and/or post-processing may adversely affect the determination of the first property, since for instance rounding errors may be introduced in this manner and the determination may be slowed down by additional processing steps. Thus, this method may further facilitate an improved determination of the value of the first property.

For example, a property may be the rock type, wherein integer values of 1, 2, 3 and 4 represent the rock types “siltstone (high porosity)”, “siltstone (low porosity)”, “shale” and “dolomite”, respectively. Further properties may also be classified as integer values. Using and conserving an integer-value data type, which represents a value of a property or of properties may be achieved by integer programming, which provides the advantage that even less computer memory needs to be consumed in case the method is applied on a computer. Integer programming may be understood as a technique, wherein values of properties may be restricted to be integers. In particular, an integer may require less memory than a float data type or other data types.

Further preferred, the second data type is different from an integer-value data type, preferably a real-value data type. The second data type may be conserved during the step of performing the optimization operation. Further preferred, the second data type is conserved during any or all steps of the method. For example, the first property is an integer-value data type, and the second property is a real-value data type. The method thus preferably allows for handling properties of integer-value data types and real-value data types at the same time. This may be advantageous, since properties, such as a displacement in one direction, may be conserved or maintained as a real-value data type throughout the optimization operation or any or all steps of the method, while another property or other properties may be conserved as integer-value data types.

Thus, both data-types can be handled with simultaneously by the method, for instance during the optimization operation. Thereby, no pre-and/or post-processing may be required to alter a data type before and/or after the optimization operation or during any other step of the method.

In a further preferred embodiment, performing the optimization operation comprises: providing an initial generative adversarial network, GAN; training the initial GAN using at least partially the first uncertainty distribution, the predetermined value of the second property, the relationship between the properties, and/or the input value of the third property, optionally using predetermined data associated with the reservoir, to obtain a trained GAN; and using the trained GAN in determining the value of the first property. Thus, a GAN is used to determine the value of the first property in a fast and cost-efficient manner. The initial GAN is provided and then trained. Beneficially this may require less training data as compared to typical neural networks, since the initial GAN and the trained GAN each comprise two neural networks. Training data for the initial GAN may be the first uncertainty distribution, the predetermined value of the second property, the relationship and/or the input value of the third property. Further, it may be possible to use additional predetermined data associated with the reservoir. This additional predetermined data may be referred to as values of the first, second and/or third property or, in another example, other properties of the reservoir. The GAN may be provided with a generator as a first neuronal network, which generates one or more potential values, and a discriminator as a second neuronal network, which evaluates and/or corrects the generated one or more potential values. The algorithmic architecture of the GAN may thereby use the two neural networks in order to generate improved one or more potential values. This may comprise an improved potential value of the first property. Applying the obtained or trained GAN allows for decreasing the computational time in determining the value of the first property by using the generator and discriminator, i.e. both neural networks. Thus, the method can advantageously address a holistic data determination instead of optimizing individual data points by using a GAN. Therefore, it may be possible to address the calculation of a control variable, for instance the third property, at the highest rank and simultaneously determine the unknown value of the property, for instance the first property. The determination of unknown properties may be improved and more performant by using a GAN. For instance, compared to particle swarm optimization (PSO), the GAN may allow for simultaneously determining properties across an entire domain instead of determining a specific data type one value at a time.

In another preferred embodiment, performing the optimization operation comprises: applying at least one surrogate function, based at least in part on a subset of predetermined values of the first property; and using at least partially the at least one surrogate function and the input value of the third property in determining the value of the first property. For example, the optimization operation comprises applying a Bayesian optimization. It may be the case that some values of a property are known but other values of this property are not known. In an example a multitude of values of the first property are needed but merely a small amount of data is given. In another example the relationship may be at least partially ill-defined or not known. In another example, a multitude of values of the first property are needed but merely a small amount of data is given and also the relationship is at least partially ill-defined or not known. In at least one of the above-mentioned examples, the method facilitates providing one or more surrogate functions. These one or more surrogate functions may resemble a small amount of data that is given, i.e. some values of the first property. Then, the one or more surrogate functions may advantageously be updated improve the accuracy, for instance between the small amount of data that is given and the surrogate function to improve the accuracy in the remaining data range. Therefore, this embodiment may beneficially cope with small data relationship(s), such as physical or empirical relationship(s), that is (are) ill-defined or undefined. This embodiment of the inventive method may further be performant, since it does not necessitate to evaluate one or more derivatives to improve accuracy.

In a further preferred embodiment, the method further comprises: validating the determined value of the first property based at least in part on a predetermined value of the first property, preferably prior to applying the determined value of the first property in simulating the at least one characteristic of the hydrocarbon subterranean reservoir. The validation may serve to determine the accuracy of the determined value of the first property. The first property may be a static or dynamic property. A static property or static properties of the reservoir is/are typically derived from static tests associated with a core sample of the reservoir. A dynamic property or dynamic properties may be derived from wireline measurements of compressional, shear acoustic velocities and/or rock density. Both, a static and a dynamic property may refer for instance to a property such as the young's modulus, but they may be subject to different aspects of that property, such as a time aspect. The validation of static properties may comprise determining a statistical confidence interval of realizations. The validation of static properties may also comprise minimizing a difference of a determined value of a property, such as the first property with respect to one or more known values of this property if, for example, the previously unknown values of this property may have only been limited, i.e. some values but not all values were known. The validation of dynamic properties may comprise determining at least one statistical confidence interval of realizations. This interval of realizations may include generated realizations from determined values by the method, that are previously unknown, optionally by involving the generated realizations from the determined values. The validation of dynamic properties may also comprise minimizing a difference of a determined value of a property, such as the first property with respect to one or more known values of this property if, for example, the previously unknown values of this property may have only been limited, i.e. some values but not all values were known. In this regard, a part of the values of the first property may be known, for instance this part of the values of the first property may be observed or measured. In another example, this part of the values of the first property may be retrieved from simulation. Herein, “realizations” may be understood as data or values that are generated, determined or estimated for unknown data or properties. The validation may not be limited to the applicability of the inventive method as described herein but may also be applicable to metaheuristic optimization techniques like a variable neighbor particle swarm optimization (VNPSO) with exterior penalty function (EPF).

In a preferred embodiment, the method further comprises: transferring the first uncertainty distribution of the first property, the predetermined value of the second property and/or the input value of the third property into one or more quantum states, preferably based on a predetermined range of values associated with the first property, the second property and/or the third property, preferably prior to step of performing the optimization operation; wherein performing the optimization operation comprises using at least partially the one or more quantum states in determining the value of the first property. For example, this is achieved by applying quantum computing. Quantum computing allows for further reducing the computational time in determining the value of the first property. The values of the properties may be computed considering the quantum states, e.g. as applicable by one or more qubits or qbits. As an example, once measured, a qubit or qbit may be in either one of the defined state of |0 [symbol] or |1 [symbol] , wherein |0 [symbol] or |1 [symbol] may an orthonormal basis for a two-dimensional vector space. Quantum superposition may ensure that n qubits exist in a superposition of 2ⁿ (two to the power of n) states. This may allow to exponentially explore complex interactions across a physically plausible numerical solution for a single given unknown in the dataset. Further, due to quantum entanglement measurements for multiple unknowns within the dataset may be executed simultaneously. The values may be defined by way of the quantum states according to the laws of quantum physics. Quantum computing provides for superposition and entanglement. Superposition may be seen as a linear combination of other distinct quantum states. The quantum state in superposition may form a new valid quantum state. A quantum state may be described by a quantum particle. Measurement of a quantum particle in superposition may lead to the determination of a state solution of an unknown value of a property, such as the first property or unknown values of one or more properties in case there are multiple unknown values of multiple properties in any and/or across multiple dimensions, such as across different spatial dimensions. Classical computers, using one or more bits cannot provide for superposition. Thus, quantum computing is performant and provides for a fast determination of a value of the first property. Further, in quantum mechanics, quantum particles may be entangled when a quantum state of each particle may not be described independently of the quantum state of the other particle. The quantum state of the system as a whole, wherein the system may comprise all quantum particles can however be described. Thus, the quantum state may comprise further values between 0 and 1 as compared to classical bits. This decreases computational time. The quantum states may advantageously be scaled according to the range of physically plausible or applicable solutions in the space for the intended unresolved or unknown data. Scaling may be understood by the following example: a quantum computer may be employed to determine a (previously unknown) value of parameter h that satisfies a function g(h) as a minimum. Further, superposition states that are created may be leveraged so that g(h) can be applied to a range of physically plausible or applicable solutions simultaneously. Further still, a quantum interference effect that may be tied to a pseudo-objective function, can be applied to bias the measurement of the qubits or qbits to a desired set of states. Therefore, quantum computing further improves simulating the at least one characteristic of the reservoir by a faster determination of the value of the first property.

In another preferred embodiment, performing the optimization operation comprises: providing an updated first uncertainty distribution of the first property based at least in part on the determined value of the first property, preferably prior to applying the determined value of the first property in simulating the at least one characteristic of the hydrocarbon subterranean reservoir, e.g. step b); and repeating the step of performing the optimization operation using at least partially the updated first uncertainty distribution in replacement of the first uncertainty distribution to determine an updated value of the first property to be used in replacement of the determined value of the first property for step b). In this preferred embodiment, a Stochastic Simplex Approximate Gradient technique is applied, preferably in combination with applying bootstrapping. The Stochastic Simplex Approximate Gradient technique is a gradient based optimization technique, such that it typically determines derivatives to reach or come close to an objective. In this embodiment, after the value of the first property is determined, a bootstrapping technique is employed to exploit the general connectedness of the solution space at the solution, i.e. the value of the first property. Bootstrapping advantageously generates a range of different values of the first property by varying the first solution and calculating, for instance, the L1-Norm or L2-Norm. Bootstrapping may be applied to any optimization operation that is applied in the context of the method according to the present invention and in particular in the context of step a4) of the method according to the present invention. For instance, bootstrapping may be applied when minimizing a difference between the input value of the third property and a calculated value wherein the calculated value may be determined using the relationship between the properties, the first uncertainty distribution and the predetermined value of the second property. Bootstrapping may also be applied when performing the optimization operation comprises providing an initial and/or trained GAN. As will be appreciated by the person skilled in the art, bootstrapping may generally be applied to any optimization operation. This may be repeated until a specified allowable change in the L1- or L2-Norm occurs. This embodiment facilitates to efficiently account for uncertainty underlying a property of the method. The embodiment therefore further improves the determination of the value of the first property and enhances exploiting the reservoir. In particular, the application of this embodiment to data augmentation in reservoir characterization and the determination of reservoir properties is advantageous, since the reservoir can be described more accurately.

Preferably, the method step of providing the first uncertainty distribution of the first property of the reservoir further comprises providing a second uncertainty distribution of the second property of the reservoir, wherein performing the optimization operation further comprises using at least partially the second uncertainty distribution in determining the value of the first property. Thus, the method also provides for an uncertainty of a known property. For instance, values of the second property may be known, however, these values may still be subject to variations under realistic conditions. These variations that are typically inherent to such a property can advantageously be considered with the second uncertainty distribution.

Preferably, the properties of the reservoir are static and/or dynamic properties of the reservoir and/or the properties of the reservoir are at least one of the list comprising P-impedance, S-impedance, density, resistivity, gamma-ray, primary-wave velocity (Vp) to secondary-wave velocity (Vs) ratio, porosity, Poisson's ratio, effective stress, displacement, such as horizontal displacement, vertical displacement or displacement in depth, pressure, saturation, porosity, permeability. The properties of the reservoir may also be one of a capillary pressure, phase saturation, relative permeability for any phase of a fluid of the reservoir and/or fluid properties, such as e.g. oil viscosity.

Preferably, providing the predetermined value of the second property and/or providing the input value of the third property comprises measuring the respective value, preferably by well logging and/or sonic logging the respective values.

In a preferred embodiment, the method further comprising applying the determined value of the first property in: optimizing exploitation of the reservoir, such as hydrocarbon production, production times and/or production rates of the reservoir; monitoring a connectivity and/or a compartment of the reservoir; and/or determining at least one well placement for exploiting the reservoir. The method can be used in a multitude of technical applications and may improve exploitation of a hydrocarbon subterranean reservoir. For example, the determined value of the first property may be applied for identifying optimal hydrocarbon reservoir production times and/or rates. In particular, if a multitude of values of the first property is previously missing or values of several properties are not known and potentially connected according to a relationship, the method provides for advances in exploiting a reservoir.

The method may not be limited to be applied to reservoir production optimization but can generally be applied to determine or generate data to aid in characterizing the reservoir. Applying the determined value of the first property may further improve or enable decision making or can be leveraged to execute further workflows that are dependent upon data, data types or properties that are ill-defined or unresolved or whose values are not known. Furthermore, a range of relationships may be considered that can be dependent upon properties of the reservoir having values of different data types. The properties may be related to wireline logs, think sections, production or rock physics models. Further examples of properties may comprise rock types, realization, route, and ranking type answers that may only be described as integer values data types.

Another aspect of the invention relates to a system for simulating at least one characteristic of a hydrocarbon subterranean reservoir for exploiting said reservoir, wherein the reservoir is characterized by at least a first, a second, and a third property, wherein the first, the second, and the third properties are different from one another and linked to each other according to a relationship, the system comprising: means for determining a value of the first property of the reservoir, comprising: means for providing a predetermined value of the second property of the reservoir, means for providing an input value of the third property of the reservoir; means for providing a first uncertainty distribution of the first property of the reservoir; means for determining the value of the first property using at least partially the first uncertainty distribution, the predetermined value of the second property, the relationship between the properties, and the input value of the third property; means for applying the determined value of the first property in simulating at least one characteristic of the hydrocarbon subterranean reservoir for exploiting said reservoir.

The system may be used to determine the value of the first property and to simulate at least one reservoir characteristic. The system may determine this value and/or simulate the at least one characteristic automatically or by way of user interaction. For example, the simulation by way of the system may be started and/or stopped by a user. The means for determining, for providing and/or for applying may be physical means or may be represented by, for instance, a computer or computer program. It is to be understood that advantages and/or features of the methods may also apply to the system and vice versa. Further, the system according to the present disclosure may serve to perform one or all of the method steps as described above. In one example, the first uncertainty distribution may be described by a uniform shape, such that each value occurs with the same likelihood. For example, the first uncertainty distribution may also be considered as a range of values or a range of plausible values. Preferably, the distribution has a shape that is not uniform. A not uniform shape of the distribution may be understood such that values of the distribution in the range of x1 and x2 occur with a different likelihood and/or that at least one value has a different likelihood of occurrence than one or more of the other values.

The means for determining a value of the first property of the reservoir may be configured such, the value of the first property is calculated, derived or otherwise retrieved and may comprise one or more of the following means.

The means for providing a predetermined value of the second property of the reservoir may be configured such, that e.g. a value of the second property is provided by way of measurements or previously known values of the second property.

The means for providing an input value of the third property of the reservoir may be configured such, that e.g. a value of the third property is provided by way of measurements or previously known values of the third property and then used as input value for the third property.

The means for providing a first uncertainty distribution of the first property may be configured such, that an uncertainty distribution is calculated, determined, or otherwise retrieved, wherein the uncertainty distribution is associated with the first property.

The means for determining the value of the first property may be configured such, that the value of the first property is calculated, derived or otherwise retrieved such that the value is known.

The means for applying the determined value of the first property in simulating at least one characteristic of the reservoir may be configured such that the at least one characteristic of the reservoir may be analyzed, assessed, examined, or otherwise evaluated to derive information about the reservoir, which were not available before the system's advantageous contribution.

The system may be applied to determine the value of the first property in a fast and cost-efficient manner, which may further allow to simulate at least one characteristic of the reservoir. Thus, the system facilitates exploitation of the reservoir. Furthermore, the system enhances decision making for instance for improved well placements and well operation and thus provides for cost-effective and economic advantages.

The means for providing something may also be one means or the same means.

A further aspect of the invention relates to a system for simulating at least one characteristic of a hydrocarbon subterranean reservoir for exploiting said reservoir, wherein the reservoir is characterized by at least a first, a second, and a third property, wherein the first, the second, and the third properties are different from one another and linked to each other according to a relationship, the system comprising: a computing unit, for determining a value of the first property of the reservoir, comprising: a first data acquisition unit, for providing a predetermined value of the second property of the reservoir, a second data acquisition unit, for providing an input value of the third property of the reservoir; a third data acquisition unit, for providing a first uncertainty distribution of the first property of the reservoir; an optimizer unit, for determining the value of the first property using at least partially the first uncertainty distribution, the predetermined value of the second property, the relationship between the properties, and the input value of the third property; a processing unit, for applying the determined value of the first property in simulating at least one characteristic of the hydrocarbon subterranean reservoir for exploiting said reservoir.

The first, second and third data acquisition unit may also be one data acquisition unit.

The system or the different means may advantageously be configured to perform the method as described above.

A further aspect of the invention relates to a computer program comprising instructions which, when the program is executed by a computer, cause the computer to carry out the method described above.

### BRIEF DESCRIPTION OF THE FIGURES

In the following, the accompanying figures are briefly described:

FIG. 1 illustrates a flow chart of a method for simulating at least one characteristic of a hydrocarbon subterranean reservoir for exploiting said reservoir according to an embodiment,

FIG. 2 illustrates a system for simulating at least one characteristic of a hydrocarbon subterranean reservoir for exploiting said reservoir according to another embodiment of the invention, and

FIG. 3 illustrates a conceptual example of an embodiment according to an aspect of the present invention by way of the Geertsma displacement.

### DETAILED DESCRIPTION OF THE FIGURES

In the following, the invention is described with reference to the accompanying figures in more detail.

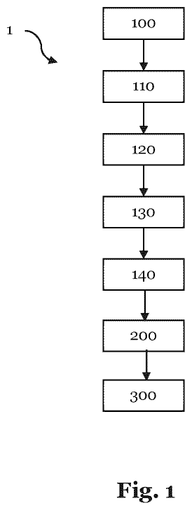

FIG. 1 illustrates a flow chart of a method 1 for simulating at least one characteristic of a hydrocarbon subterranean reservoir for exploiting said reservoir according to an embodiment of the invention. Exploiting a reservoir may also comprise exploration, production and recovery of hydrocarbons. Simulating at least one characteristic of a reservoir may also be important for strategic decisions, for instance to improve economic and also environmental aspects associated with the earth's natural resources.

The method 1 is implemented as a process for determining a value of a property of the reservoir, wherein a value of the property is unknown, ill-defined or too complicated to be measured or otherwise retrieved. The unknown value of the property may be for instance the porosity of the rock with respect to space and time. Knowledge of this parameter may improve exploiting the reservoir. The method may be entirely executed on a computer.

In step 100, values of a first property associated with a reservoir are determined comprising the following sub-steps. In step 110, predetermined values of a second property of the reservoir are provided. In step 120, input values of a third property of the reservoir are provided. Provision of these values is ensured by way of measurement data, observed data or previously known data. In step 130, a first uncertainty distribution, which may comprise a range of values of the first property of the reservoir is provided. This uncertainty distribution allows for consideration of statistical variances associated with the values of the first property in a suitable physical range. The first, second and third property are linked to each other according to a relationship. The method may also allow to provide a second uncertainty distribution, which may comprise a numerical range for the second property. Thus, its variation may also be considered for by the method. The properties may also be multi-dimensional and dependent upon space and time. Thus, the relationship is complicated in nature and cannot be easily solved for the unknown data. In step 140, an optimization operation is performed to determine the value of the first property. This step may comprise using a generative adversarial network, GAN, to beneficially use two neural networks, preferably trained with properties associated with the reservoir to determine the value of the first property. The data type of the properties may be different. For instance, “lithology” may be classified according to integer values, wherein the properties “displacement” and “density” are described with real values. Both data types are reflected and conserved during method 1. Thus, no pre-and/or post-processing is required and the accuracy of the determined value of the first property is increased whilst reducing the computational cost. Steps 130 and 140 may also be repeated by applying a Stochastic Simplex Approximate Gradient technique combined with bootstrapping, thereby improving the accuracy of the determined value of the first property even further. In case the relationship is not known, not precisely known, ill-defined or otherwise not available, a Bayesian optimization may be performed in the optimization operation of step 140. The third property may thus be treated as a black-box and surrogate functions resemble at least part of values of the first property that are required to be known in order to determine the remaining values of the first property. As an example, it may be sufficient to know 10%, 20%, 30% or more of the values of the first property.

In step 200, a validation is performed to determine a statistical confidence interval of realizations to evaluate the accuracy of the determined value of the property. For this, at least some data of the determined property may need to be known. This validation step may be optional but may provide for a valuable assessment of the determined value of the property.

In step 300, the determined value of the first property, or the values that have been determined and that were previously unknown, is/are applied to simulate the at least one characteristic of the hydrocarbon subterranean reservoir for exploiting the reservoir. This comprises a multitude of tasks associated with the reservoir and expands and extends the overall reservoir and production lifecycles. For instance, method step 300 or the method 1 can be applied even before production has started.

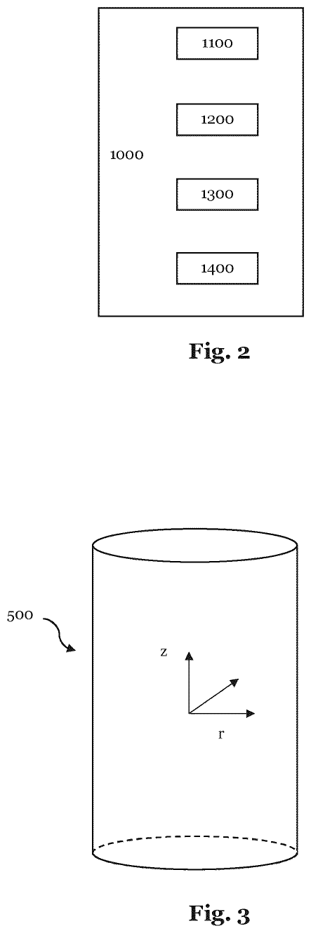

FIG. 2 illustrates a system 1000 for simulating at least one characteristic of a hydrocarbon subterranean reservoir for exploiting said reservoir according to another embodiment of the invention. The reservoir is characterized by at least a first, a second, and a third property, wherein the first, the second, and the third property are different from one another and linked to each other according to a relationship. The properties are multi-dimensional, e.g. dependent upon space in three dimensions and in time. The system 1000 comprises a computing unit 1100 for determining a value or values of the first property of the reservoir. The computing unit 1100 further comprises a data acquisition unit 1200 for providing a predetermined value or values of the second property of the reservoir, an input value or values of the third property of the reservoir and a first uncertainty distribution of the first property of the reservoir. The computing unit 1100 further comprises an optimizer unit 1300 for determining the value of the first property using at least partially the first uncertainty distribution, the predetermined value of the second property, the relationship between the properties, and the input value of the third property. The system 1000 further comprises a processing unit 1400 for applying the determined value of the first property in simulating the at least one characteristic of the hydrocarbon subterranean reservoir for exploiting said reservoir.

FIG. 3 illustrates a conceptual example of an embodiment according to an aspect of the present invention by way of the Geertsma displacement perpendicular free surface displacement from a nucleus-of-strain.

The mathematical problem associated with the Geertsma perpendicular free surface displacement from a nucleus-of-strain may be described as follows. An extraction of liquids or gas of a reservoir 500 may cause compaction of the reservoir 500 and may alter the stress and deformation fields in the surrounding rocks. As an example, the reservoir 500 may be described as a cylinder. This exemplary configuration has been analyzed theoretically by Geertsma providing a relationship of displacement and stresses. The property u_{z}, which may be the third property according to the invention, is the vertical displacement and is related to other properties according to relationship (1) below. Therein, r is the radius and z is the vertical axis; both of which are depicted in FIG. 3 for illustrative purpose along with another axis to describe a space of the reservoir 500. In this case, the relationship between cₘ, υ, Δp, H, R, the integral and u_{z} (symbols explained below) is a mathematical equation.

$${u}_{z} ( r , 0 ) = - 2 {c}_{m} ( 1 - v ) Δ pHR {\int }_{0}^{∞} {e}^{- D α} {J}_{1} ( α R ) {J}_{0} ( α R ) d α \qquad ( 1 )$$

In this embodiment, the values of the uniaxial compaction coefficient (cₘ) and the Poisson's ratio (υ) may not be known. The values of the pressure difference (Δp), the thickness of the productive reservoir 500 (H), and of the radius of the reservoir 500 (R) may be known. The properties Δp, H and R, whose values may be known, may also be referred to as the second property or the second properties. The terms J₀ and J₁ are defined as the zero and first order Bessel functions, respectively. The solution to the integral in the relationship (1) can be determined analytically.

A profile of the displacement in the vertical direction u_{z}^{given}(r, 0) may be given, known, observed, recorded or otherwise be given. This may have been achieved by appropriate measurements and/or by sonic log data of well log data and/or by seismic data that is associated with a hydrocarbon subterranean reservoir 500. Further the given profile may be known from historic data.

An uncertainty distribution is given for one or all properties whose values are not known across a defined numerical range of values of these properties. Each unknown property may be provided with an individual uncertainty distribution. Advantageously, the defined numerical range is designed for each property individually. For instance, the Poisson's ratio (υ) may be provided with an uncertainty distribution wherein the values range from 0.1 to 0.5 in one example. In another example the values range from 0.2 to 0.4 or 0.36, such as in fluid saturated carbonate rocks. For saturated sand, the values may range from 0.07 to 0.5 and for saturated soft clays the range may be from 0.4 to 0.5. Based on these distributions and the known properties, the relationship (1) is used to determine estimates of u_{z}(r, 0). These estimates are denoted as u_{z}^{opt}(r, 0), since they represent a best guess or even optimal solution as explained below.

This step may also involve uncertainties associated with the known properties, i.e. the known properties (Δp, H, and R) may also be provided with an uncertainty distribution across a defined numerical range.

The step of determining estimates of u_{z}(r, 0) (denoted as u_{z}^{opt}(r, 0)) may also be referred to as sampling estimates of u_{z}(r, 0) (denoted as u_{z}^{opt}(r, 0)). This method may comprise the step of sampling estimates of u_{z}(r, 0) (denoted as u_{z}^{opt}(r, 0)) sequentially or simultaneously. For simultaneous sampling quantum computing and/or a generative adversarial network, GAN, may be used.

A deviation between recorded u_{z}^{given}(r, 0) and estimates of u_{z}^{opt}(r, 0) is determined or calculated to find a best guess of u_{z}^{opt}(r, 0). In an example, a L1-Norm is used to find a best guess of u_{z}^{opt}(r, 0). In another example, a L2-Norm is used to find a best guess of u_{z}^{opt}(r, 0). In another example, finding a best guess can be achieved by the following equation (2), which may be performed, for instance, on a node-by-node, or geo-cellular cell-by-cell basis depending on the structure of the properties:

$$\vert {u}_{z}^{given} ( r , 0 ) - {u}_{z}^{opt} ( r , 0 ) \vert \qquad ( 2 )$$

As a result, the values of the properties (cₘ and υ) have been determined, that yield to the best guess or optimal solution u_{z}^{opt}(r, 0). Accordingly, this method beneficially provides for determining values of properties, whose values were not known previously, in a statistically robust manner by way of considering an uncertainty of the unknown properties.

### LIST OF REFERENCE SIGNS

1 method
100 method step: determining
110 method step: providing
120 another method step: providing
130 a further method step: providing
140 method step: performing
200 validating
300 applying
500 reservoir
1000 system
1100 computing unit
1200 data acquisition unit
1300 optimizer unit
1400 processing unit

1. A method for simulating at least one characteristic of a hydrocarbon subterranean reservoir for exploiting said reservoir, wherein the reservoir is characterized by at least a first, a second, and a third property, wherein the first, the second, and the third properties are different from one another and linked to each other according to a relationship, the method comprising the steps of:
a) determining a value of the first property of the reservoir, comprising the steps of:
a1) providing a predetermined value of the second property of the reservoir;
a2) providing an input value of the third property of the reservoir;
a3) providing a first uncertainty distribution of the first property of the reservoir;
a4) performing an optimization operation using at least partially the first uncertainty distribution, the predetermined value of the second property, the relationship between the properties, and the input value of the third property in determining the value of the first property;
b) applying the determined value of the first property in simulating the at least one characteristic of the hydrocarbon subterranean reservoir for exploiting said reservoir.

2. The method of claim 1, wherein performing the optimization operation comprises:
calculating sampling values of the first property based at least partially on the first uncertainty distribution of the first property;
calculating output values of the third property based at least partially on the relationship between the properties and the calculated sampling values of the first property;
selecting a value of the calculated output values of the third property closest to the input value of the third property; and
determining the respective value of the first property from the calculated sampling values of the first property corresponding to the selected value of the calculated output values of the third property closest to the input value of the third property.

3. The method of claim 1, wherein the values of one or more of the first property, second property, third property has a first data type, and wherein the values of one or more other of the first property, second property, third property has a second data type different from the first data type.

4. The method of claim 3, wherein the first data type is an integer-value data type, and
wherein the first data type is conserved during the step of performing the optimization operation,
wherein the first data type is preferably conserved during any step of the method.

5. The method of claim 3, wherein the second data type is different from an integer-value data type, preferably wherein the second data type is a real-value data type, and
wherein the second data type is conserved during the step of performing the optimization operation,
wherein the second data type is preferably conserved during any step of the method.

6. The method of claim 1, wherein performing the optimization operation comprises:
providing an initial generative adversarial network, GAN;
training the initial GAN using at least partially the first uncertainty distribution, the predetermined value of the second property, the relationship between the properties, and/or the input value of the third property, optionally using predetermined data associated to the reservoir, to obtain a trained GAN; and
using the trained GAN in determining the value of the first property.

7. The method of claim 1, wherein performing the optimization operation comprises:
applying at least one surrogate function, based at least in part on a subset of predetermined values of the first property; and
using at least partially the at least one surrogate function and the input value of the third property in determining the value of the first property.

8. The method of claim 1, wherein the method further comprises:
validating the determined value of the first property based at least in part on a predetermined value of the first property, preferably prior to step b).

9. The method of claim 1, wherein the method further comprises:
transferring the first uncertainty distribution of the first property, the predetermined value of the second property and/or the input value of the third property into one or more quantum states, preferably based on a predetermined range of values associated with the first property, the second property and/or the third property, preferably prior to step a4),
wherein performing the optimization operation comprises using at least partially the one or more quantum states in determining the value of the first property.

10. The method of claim 1, wherein performing the optimization operation comprises:
providing an updated first uncertainty distribution of the first property based at least in part on the determined value of the first property, preferably prior to step b); and
repeating step a4) using at least partially the updated first uncertainty distribution in replacement of the first uncertainty distribution to determine an updated value of the first property to be used in replacement of the determined value of the first property for step b).

11. The method of claim 1, wherein providing the first uncertainty distribution of the first property of the reservoir comprises:
providing a second uncertainty distribution of the second property of the reservoir; and wherein performing the optimization operation further comprises:
using at least partially the second uncertainty distribution in determining the value of the first property.

12. The method of claim 1, wherein the properties of the reservoir are static and/or dynamic properties of the reservoir and/or wherein the properties of the reservoir are at least one of the list comprising P-impedance, S-impedance, density, resistivity, gamma-ray, primary-wave velocity (Vp) to secondary wave velocity (Vs) ratio, porosity, Poisson's ratio, effective stress, displacement, such as horizontal displacement, vertical displacement or displacement in depth, pressure, saturation, porosity, permeability.

13. The method of claim 1, wherein providing the predetermined value of the second property and/or providing the input value of the third property comprises measuring the respective value, preferably by well logging and/or sonic logging the respective values.

14. The method of claim 1, further comprising applying the determined value of the first property in:
optimizing exploitation of the reservoir, such as hydrocarbon production, production times and/or production rates of the reservoir;
monitoring a connectivity and/or a compartment of the reservoir, and/or
determining at least one well placement for exploiting the reservoir.

15. A system for simulating at least one characteristic of a hydrocarbon subterranean reservoir for exploiting said reservoir, wherein the reservoir is characterized by at least a first, a second, and a third property, wherein the first, the second, and the third properties are different from one another and linked to each other according to a relationship, the system comprising:
a) means for determining a value of the first property of the reservoir comprising:
a1) means for providing a predetermined value of the second property of the reservoir;
a2) means for providing an input value of the third property of the reservoir;
a3) means for providing a first uncertainty distribution of the first property of the reservoir;
a4) means for determining the value of the first property using at least partially the first uncertainty distribution, the predetermined value of the second property, the relationship between the properties, and the input value of the third property;
b) means for applying the determined value of the first property in simulating the at least one characteristic of the hydrocarbon subterranean reservoir for exploiting said reservoir.

16. A computer program comprising instructions which, when the program is executed by a computer, cause the computer to carry out the method of claim 1.
